(19) United States
(12) Patent Application Publication
(10) Pub. No.: US 2025/0008384 A1
(43) Pub. Date: Jan. 2, 2025

(54) MEASUREMENT REPORT INDICATING ONGOING MEASUREMENTS

(71) Applicant: Lenovo (Singapore) Pte. Ltd., New Tech Park (SG)

(72) Inventors: Prateek Basu Mallick, Dreieich (DE); Joachim Löhr, Wiesbaden (DE)

(21) Appl. No.: 18/759,223

(22) Filed: Jun. 28, 2024

Related U.S. Application Data
(60) Provisional application No. 63/511,554, filed on Jun. 30, 2023.

(51) Int. Cl. H04W 36/00; H04W 24/10

(52) U.S. Cl. CPC H04W 36/0061; H04W 24/10; H04W 36/0058; H04W 36/0072; H04W 36/00835

(57) ABSTRACT

Various aspects of the present disclosure relate to receiving a first message comprising a measurement configuration, where the measurement configuration comprises a plurality of measurement identities and determining, based on measurements associated with at least a first measurement identity in the plurality of measurement identities, that a measurement reporting criterion for at least one cell is satisfied. Aspects of the present disclosure relate to generating a measurement report based on the measurements associated with at least the first measurement identity and determining whether a radio quality of a respective cell satisfies a preliminary radio threshold. Aspects of the present disclosure relate to adding, to the measurement report, an indication that another measurement is in progress and the radio quality of the respective cell satisfies the preliminary radio threshold and transmitting a second message comprising the measurement report.

### TECHNICAL FIELD

The present disclosure relates to wireless communications, and more specifically to techniques for adding an indication to a measurement report that another measurement is in progress.

### BACKGROUND

A wireless communications system may include one or multiple network communication devices, such as base stations, which may be otherwise known as an evolved NodeB (eNB), a next-generation NodeB (gNB), or other suitable terminology. Each network communication device, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology (RAT), fourth generation (4G) RAT, fifth generation (5G) RAT, among other suitable RATs beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Some implementations of the method and apparatuses described herein may include receiving a reconfiguration first message containing a measurement configuration, where the measurement configuration includes a multiple measurement identities. The method and apparatuses described herein may determine, based on measurements associated with at least a first measurement identity, that a measurement reporting criterion for at least one cell is satisfied, where a measurement or a measurement evaluation associated with a second measurement identity is ongoing. The method and apparatuses described herein may generate a measurement report based on the measurements associated with at least a first measurement identity. The method and apparatuses described herein may determine whether a radio quality of a respective cell satisfies a preliminary radio threshold. The method and apparatuses described herein may add, to the measurement report, an indication that another measurement is in progress and the radio quality of the respective cell satisfies the preliminary radio threshold. The method and apparatuses described herein may transmit a second message comprising the measurement report.

In some implementations, the method and apparatuses described herein transmit, to a UE, a reconfiguration message containing a measurement configuration, where the measurement configuration includes multiple measurement identities. The method and apparatuses described herein may receive, from the UE, a first measurement report based on measurements associated with at least a first measurement identity in the plurality of measurement identities, where the first measurement report further includes an indication that another measurement is in progress and a radio quality of an associated cell satisfies a preliminary radio threshold. The method and apparatuses described herein may start a timer upon reception of the first measurement report and may determine whether one or more second measurement reports are received from the UE prior to expiry of the timer, where the one or more second measurement reports are based on the measurements associated with at least a second measurement identity in the plurality of measurement identities. The method and apparatuses described herein may perform a handover decision for the UE based at least in part on the first measurement report, where the handover decision is further based on the one or more second measurement reports in response to the one or more second measurement reports being received from the UE prior to expiry of the timer. The method and apparatuses described herein may transmit an indication of the handover decision to the UE.

### BRIEF DESCRIPTION OF THE DRAWINGS

FIG. 1 illustrates an example of a wireless communications system in accordance with aspects of the present disclosure.

FIG. 2 illustrates an example of a Third Generation Partnership Project (3GPP) New Radio (NR) protocol stack that supports different protocol layers in the UE and network in accordance with aspects of the present disclosure.

FIG. 3 illustrates an example of a measurement configuration information element (IE) in accordance with aspects of the present disclosure.

FIG. 4 illustrates an example of a measurement procedure in accordance with aspects of the present disclosure.

FIG. 5 illustrates an example of a time-to-trigger parameter in accordance with aspects of the present disclosure.

FIG. 6A illustrates an example of an event trigger configuration in accordance with aspects of the present disclosure.

FIG. 6B is a continuation of the event trigger configuration illustrated in FIG. 6A.

FIG. 7 illustrates an example of a user equipment (UE) in accordance with aspects of the present disclosure.

FIG. 8 illustrates an example of a processor in accordance with aspects of the present disclosure.

FIG. 9 illustrates an example of a network equipment (NE) in accordance with aspects of the present disclosure.

FIG. 10 illustrates a flowcharts of method performed by a UE in accordance with aspects of the present disclosure.

FIG. 11 illustrates a flowcharts of method performed by a NE in accordance with aspects of the present disclosure.

### DETAILED DESCRIPTION

The present disclosure describes systems, methods, and apparatuses for optimized inter-frequency measurement (and/or inter-Radio Access Technology (RAT) measurements) using an indication that another measurement is in progress. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

When a UE is provisioned with a measurement configuration (e.g., configured with the MeasConfig IE) containing a list of measurement identities (e.g., a list of measID parameters) to perform several inter-frequency measurements, the measure sequence of inter-frequency measurement is not defined, and thus left to UE implementation. However, an unpredictable sequence of inter-frequency measurement and reporting may result in the UE being handed over to a non-best (i.e., inferior) radio frequency or cell. This would result in the UE shortening its time of stay in the inferior radio frequency or cell, and eventually affecting user experience due to frequent handovers or even radio link failures.

A simple solution would be for the network to indicate a priority order of the measurement identities and/or measurement objects, which the UE strictly follows and measures and reports accordingly. However, it is not clear how the serving network may determine which potential frequencies to be prioritized/down-prioritized, as the serving network cannot accurately predict or map the UE's current radio condition with respect to the UE's surrounding radio neighbors.

Moreover, if the serving network can do such prediction with higher success rate/confidence, then the serving network may just use the Blind handover mechanism to move the UE to a suitable target cell and/or frequency. However, based on the experience from the actual deployment, it is seen that Blind handovers are not used often and for a reason: the serving network cannot accurately predict the UE's mobility and/or radio conditions.

To avoid network-initiated handover to an inferior radio frequency or cell, the present disclosure describes new indication to be included by the UE in a measurement report being sent based on legacy measurement triggering criteria. Here, the new indication indicates to the network that there is an ongoing measurement or evaluation being performed by the reporting UE. In certain embodiments, the new indication (or a second indication) may additionally indicate to the network that there is at least one promising candidate in the frequencies or cells being measured and evaluated. In one implementation, the new indication in the Radio Resource Control (RRC) Measurement Report message is a Boolean flag and the UE sets the Boolean flag only if the measurement and evaluation of at least one cell or measurement object shall finish before a network configured timer expiry.

In one embodiment, when a measurement report is triggered in accordance with legacy UE behavior based on 3GPP Technical Specification (TS) 38.331 (e.g., a measurement event for a first measurement object is met) UE shall also include a new indication in the Measurement Report indicating if there are any ongoing measurement in the UE and the measurement sample(s) obtained so far suggest the preliminary measurement value(s) of one or more cells exceeding a certain network-configured threshold.

By indicating that there are ongoing measurements and/or evaluation for one or more additional measurement objects (e.g., radio frequencies and/or cells), the UE avoids being handed over to an inferior cell and possibly requiring another handover after a short amount of time. This way, network performance is enhanced, interference is reduced, and user experience is improved.

Aspects of the present disclosure are described in the context of a wireless communications system.

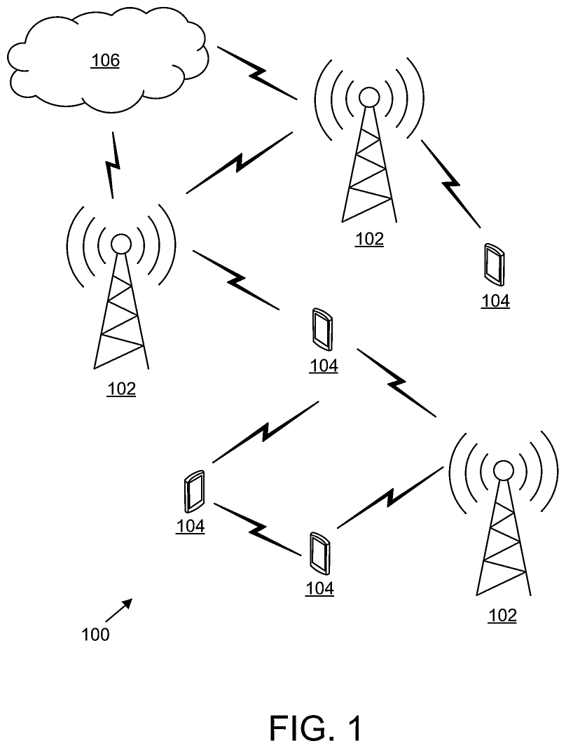

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an Long-Term Evolution (LTE) network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (CNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or a PDN connection, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., p=0) may be associated with a first subcarrier spacing (e.g., 15 kHz) and a normal cyclic prefix. In some implementations, the first numerology (e.g., p=0) associated with the first subcarrier spacing (e.g., 15 kHz) may utilize one slot per subframe. A second numerology (e.g., u=1) may be associated with a second subcarrier spacing (e.g., 30 kHz) and a normal cyclic prefix. A third numerology (e.g., u=2) may be associated with a third subcarrier spacing (e.g., 60 kHz) and a normal cyclic prefix or an extended cyclic prefix. A fourth numerology (e.g., u=3) may be associated with a fourth subcarrier spacing (e.g., 120 kHz) and a normal cyclic prefix. A fifth numerology (e.g., u=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., p=0, u=1, u=2, p=3, u=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency domain multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., p=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHZ-7.125 GHz), FR2 (24.25 GHz-52.6 GHZ), FR3 (7.125 GHz-24.25 GHZ), FR4 (52.6 GHz-114.25 GHZ), FR4a or FR4-1 (52.6 GHz-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., u=0), which includes 15 kHz subcarrier spacing; a second numerology (e.g., u=1), which includes 30 kHz subcarrier spacing; and a third numerology (e.g., u=2), which includes 60 kHz subcarrier spacing. FR2 may be associated with one or multiple numerologies (e.g., at least 2 numerologies). For example, FR2 may be associated with a third numerology (e.g., u=2), which includes 60 kHz subcarrier spacing; and a fourth numerology (e.g., u=3), which includes 120 kHz subcarrier spacing.

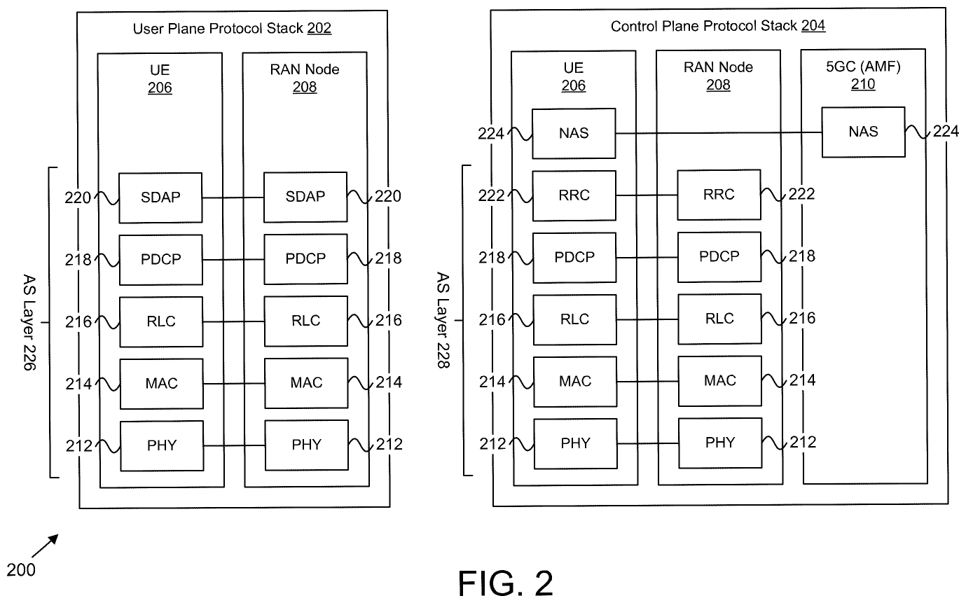

FIG. 2 illustrates an example of a protocol stack 200 for wireless communication, in accordance with aspects of the present disclosure. While FIG. 2 shows the UE 206, the RAN node 208 and a 5G core network (5GC) 210 (comprising at least an AMF), these are representative of a set of UEs 104 interacting with an NE 102 (e.g., base station) and a CN 106. As depicted, the protocol stack 200 comprises a User Plane protocol stack 202 and a Control Plane protocol stack 204. The User Plane protocol stack 202 includes a physical (PHY) layer 212, a Medium Access Control (MAC) sublayer 214, the Radio Link Control (RLC) sublayer 216, a Packet Data Convergence Protocol (PDCP) sublayer 218, and Service Data Adaptation Protocol (SDAP) layer 220. The Control Plane protocol stack 204 includes a PHY layer 212, a MAC sublayer 214, a RLC sublayer 216, and a PDCP sublayer 218. The Control Plane protocol stack 204 also includes a Radio Resource Control (RRC) layer 222 and a Non-Access Stratum (NAS) layer 224.

The AS layer 226 (also referred to as “AS protocol stack) for the User Plane protocol stack 202 consists of at least SDAP, PDCP, RLC and MAC sublayers, and the physical layer. The AS layer 228 for the Control Plane protocol stack 204 consists of at least RRC, PDCP, RLC and MAC sublayers, and the physical layer. The Layer-2 (L2) is split into the SDAP, PDCP, RLC and MAC sublayers. The Layer-3 (L3) includes the RRC layer 222 and the NAS layer 224 for the control plane and includes, e.g., an internet protocol (IP) layer and/or PDU Layer (not depicted) for the user plane. L1 and L2 are referred to as “lower layers,” while L3 and above (e.g., transport layer, application layer) are referred to as “higher layers” or “upper layers.”

The PHY layer 212 offers transport channels to the MAC sublayer 214. The PHY layer 212 may perform a beam failure detection procedure using energy detection thresholds, as described herein. In certain embodiments, the PHY layer 212 may send an indication of beam failure to a MAC entity at the MAC sublayer 214. The MAC sublayer 214 offers logical channels to the RLC sublayer 216. The RLC sublayer 216 offers RLC channels to the PDCP sublayer 218. The PDCP sublayer 218 offers radio bearers to the SDAP sublayer 220 and/or RRC layer 222. The SDAP sublayer 220 offers QoS flows to the core network (e.g., 5GC). The RRC layer 222 provides for the addition, modification, and release of Carrier Aggregation and/or Dual Connectivity. The RRC layer 222 also manages the establishment, configuration, maintenance, and release of Signaling Radio Bearers (SRBs) and Data Radio Bearers (DRBs).

The NAS layer 224 is between the UE 206 and an AMF in the 5GC 210. NAS messages are passed transparently through the RAN. The NAS layer 224 is used to manage the establishment of communication sessions and for maintaining continuous communications with the UE 206 as it moves between different cells of the RAN. In contrast, the AS layers 226 and 228 are between the UE 206 and the RAN (i.e., RAN node 210) and carry information over the wireless portion of the network. While not depicted in FIG. 2, the IP layer exists above the NAS layer 224, a transport layer exists above the IP layer, and an application layer exists above the transport layer.

The MAC sublayer 214 is the lowest sublayer in the L2 architecture of the NR protocol stack. Its connection to the PHY layer 212 below is through transport channels, and the connection to the RLC sublayer 216 above is through logical channels. The MAC sublayer 214 therefore performs multiplexing and demultiplexing between logical channels and transport channels: the MAC sublayer 214 in the transmitting side constructs MAC PDUs (also known as Transport Blocks (TBs)) from MAC Service Data Units (SDUs) received through logical channels, and the MAC sublayer 214 in the receiving side recovers MAC SDUs from MAC PDUs received through transport channels.

The MAC sublayer 214 provides a data transfer service for the RLC sublayer 216 through logical channels, which are either control logical channels which carry control data (e.g., RRC signaling) or traffic logical channels which carry user plane data. On the other hand, the data from the MAC sublayer 214 is exchanged with the PHY layer 212 through transport channels, which are classified as uplink (UL) or downlink (DL). Data is multiplexed into transport channels depending on how it is transmitted over the air.

The PHY layer 212 is responsible for the actual transmission of data and control information via the air interface, i.e., the PHY layer 212 carries all information from the MAC transport channels over the air interface on the transmission side. Some of the important functions performed by the PHY layer 212 include coding and modulation, link adaptation (e.g., Adaptive Modulation and Coding (AMC)), power control, cell search and random access (for initial synchronization and handover purposes) and other measurements (inside the 3GPP system (i.e., NR and/or LTE system) and between systems) for the RRC layer 222. The PHY layer 212 performs transmissions based on transmission parameters, such as the modulation scheme, the coding rate (i.e., the modulation and coding scheme (MCS)), the number of Physical Resource Blocks (PRBs), etc.

While the protocol stack 200 shows aspects of an NR protocol stack, note that an LTE protocol stack comprises similar structure to the protocol stack 200, with the differences that the LTE protocol stack lacks the SDAP sublayer 220 in the AS layer 226 and that the NAS layer 224 is between the UE 206 and an MME in the EPC.

The network may configure an RRC_CONNECTED UE to perform measurements. The network may configure the UE to report them in accordance with the measurement configuration or perform conditional reconfiguration evaluation in accordance with the conditional reconfiguration. The measurement configuration is provided by means of dedicated signaling i.e., using the RRCReconfiguration or RRCResume.

The network may configure the UE to perform the following types of measurements: NR measurements; Inter-RAT measurements of Evolved Universal Mobile Telecommunications System (UMTS) Terrestrial Radio Access (E-UTRA) frequencies; Inter-RAT measurements of UMTS Terrestrial Radio Access Frequency-Division Duplexing (UTRA-FDD) frequencies; NR sidelink measurements of L2 UE-to-Network (U2N) Relay UEs.

The network may configure the UE to report one or more of the following measurement information based on Synchronization Signal/Physical Broadcast Channel (SS/PBCH) block(s): Measurement results per SS/PBCH block; Measurement results per cell based on SS/PBCH block(s); SS/PBCH block(s) indexes.

The network may configure the UE to report one or more of the following measurement information based on Channel State Information Reference Signal (CSI-RS) resources: Measurement results per CSI-RS resource; Measurement results per cell based on CSI-RS resource(s); CSI-RS resource measurement identifiers.

The network may configure the UE to perform the following types of measurements for NR sidelink and V2X sidelink: Channel Busy Ratio (CBR) measurements.

The network may configure the UE to report one or more of the following Cross Link Interference (CLI) measurement information based on Sounding Resource Signal (SRS) resources: Measurement results per SRS resource; SRS resource(s) indexes.

The network may configure the UE to report one or more of the following CLI measurement information based on CLI Received Signal Strength Indicator (CLI-RSSI) resources: Measurement results per CLI-RSSI resource; CLI-RSSI resource(s) indexes.

The network may configure the UE to report the following Receive-to-Transmit (Rx-Tx) time difference measurement information based on CSI-RS for tracking or Positioning Reference Signal (PRS): UE Rx-Tx time difference measurement result.

As used herein, the measurement configuration may include one or more of the following parameters: 1) Measurement objects; 2) Reporting configurations; 3) Measurement identities; 4) Quantity configurations; 5) Measurement gaps.

As used herein, the measurement objects refer to a list of objects on which the UE shall perform the measurements. For intra-frequency and inter-frequency measurements a measurement object indicates the frequency/time location and subcarrier spacing of reference signals to be measured.

Associated with this measurement object, the network may configure a list of cell specific offsets, a list of ‘exclude-listed’ cells and a list of ‘allow-listed’ cells. Exclude-listed cells are not applicable in event evaluation or measurement reporting. Allow-listed cells are the only ones applicable in event evaluation or measurement reporting.

The measObjectId of the measurement object which corresponds to each serving cell is indicated by servingCellMO within the serving cell configuration.

For inter-RAT Evolved UMTS Terrestrial Radio Access (E-UTRA) measurements a measurement object is a single E-UTRA carrier frequency. Associated with this E-UTRA carrier frequency, the network can configure a list of cell specific offsets and a list of ‘exclude-listed’ cells. Exclude-listed cells are not applicable in event evaluation or measurement reporting.

For inter-RAT UTRA-FDD measurements a measurement object is a set of cells on a single UTRA-FDD carrier frequency.

For NR sidelink measurements of L2 U2N Relay UEs, a measurement object is a single NR sidelink frequency to be measured.

For CBR measurement of NR sidelink communication, a measurement object is a set of transmission resource pool(s) on a single carrier frequency for NR sidelink communication.

For CBR measurement of NR sidelink discovery, a measurement object is a set of discovery dedicated resource pool(s) or transmission resource pool(s) also used for NR sidelink discovery on a single carrier frequency for NR sidelink discovery.

For CLI measurements a measurement object indicates the frequency/time location of SRS resources and/or CLI-RSSI resources, and subcarrier spacing of SRS resources to be measured.

As used herein, the reporting configurations refer to a list of reporting configurations where there can be one or multiple reporting configurations per measurement object. Each measurement reporting configuration consists of the following: 1) Reporting criterion; 2) Reference Signal (RS) type; 3) Reporting format.

As used herein, the reporting criterion refers to the criterion that triggers the UE to send a measurement report. This can either be periodical or a single event description.

Here, the RS type refers to the RS that the UE uses for beam and cell measurement results (SS/PBCH block or CSI-RS).

As used herein, the reporting format refers to the quantities per cell and per beam that the UE includes in the measurement report (e.g., Reference Signal Received Power (RSRP) and/or Reference Signal Receive Quality (RSRQ)) and other associated information such as the maximum number of cells and the maximum number beams per cell to report.

In case of conditional reconfiguration, each configuration consists of the following: 1) Execution criteria; 2) RS type.

As used herein, the term “execution criteria” refers to the criteria the UE uses for conditional reconfiguration execution.

Here, the RS type refers to the RS that the UE uses for obtaining beam and cell measurement results (SS/PBCH block-based or CSI-RS-based), used for evaluating conditional reconfiguration execution condition.

As used herein, for measurement reporting, the term “measurement identities” refers to a list of measurement identities where each measurement identity links one measurement object with one reporting configuration. By configuring multiple measurement identities, it is possible to link more than one measurement object to the same reporting configuration, as well as to link more than one reporting configuration to the same measurement object.

The measurement identity is also included in the measurement report that triggered the reporting, serving as a reference to the network. For conditional reconfiguration triggering, one measurement identity links to exactly one conditional reconfiguration trigger configuration. And up to two measurement identities can be linked to one conditional reconfiguration execution condition.

As used herein, the quantity configuration defines the measurement filtering configuration used for all event evaluation and related reporting, and for periodical reporting of that measurement. For NR measurements, the network may configure up to two quantity configurations with a reference in the NR measurement object to the configuration that is to be used. In each configuration, different filter coefficients can be configured for different measurement quantities, for different RS types, and for measurements per cell and per beam.

As used herein, the term “measurement gaps” refers to periods that the UE may use to perform measurements. A UE in RRC_CONNECTED maintains a measurement object list, a reporting configuration list, and a measurement identities list according to signaling and procedures in this specification.

The measurement object list possibly includes NR measurement object(s), CLI measurement object(s), inter-RAT objects, and L2 U2N Relay objects. Similarly, the reporting configuration list includes NR, inter-RAT, and L2 U2N Relay reporting configurations. Any measurement object can be linked to any reporting configuration of the same RAT type. Some reporting configurations may not be linked to a measurement object. Likewise, some measurement objects may not be linked to a reporting configuration.

The measurement procedures distinguish the following types of cells: 1) The NR serving cell(s)—these are the Special Cell (SpCell) and one or more Secondary Cells (SCells); 2) Listed cells—these are cells listed within the measurement object(s); and 3) Detected cells—these are cells that are not listed within the measurement object(s) but are detected by the UE on the Synchronization Signal Block (SSB) frequency (ies) and subcarrier spacing(s) indicated by the measurement object(s). As used herein, the SpCell refers to the Primary Cell (PCell) or a Primary Secondary Cell (PSCell).

For NR measurement object(s), the UE measures and reports on the serving cell(s)/serving Relay UE (for L2 U2N Remote UE), listed cells and/or detected cells. For inter-RAT measurements object(s) of E-UTRA, the UE measures and reports on listed cells and detected cells and, for Received Signal Strength Indicator (RSSI) and channel occupancy measurements, the UE measures and reports on the configured resources on the indicated frequency. For inter-RAT measurements object(s) of UTRA-FDD, the UE measures and reports on listed cells. For CLI measurement object(s), the UE measures and reports on configured measurement resources (i.e., SRS resources and/or CLI-RSSI resources). For L2 U2N Relay object(s), the UE measures and reports on the serving NR cell(s), as well as the discovered L2 U2N Relay UEs.

Below, whenever the specification refers to a field it concerns a field included in the variable VarMeasConfig unless explicitly stated otherwise, i.e., only the measurement configuration procedure covers the direct UE action related to the received measConfig IE.

In NR Dual Connectivity (NR-DC), the UE may receive two independent measConfig IEs: a measConfig IE associated with a Master Cell Group (MCG), and a measConfig IE associated with a Secondary Cell Group (SCG). The measConfig IE associated with MCG is included in the RRCReconfiguration message received via Signaling Radio Bearer #1 (SRB1). The measConfig IE associated with SCG is included in the RRCReconfiguration message received via Signaling Radio Bearer #3 (SRB3), or, alternatively, included within a RRCReconfiguration message embedded in a RRCReconfiguration message received via SRB1.

In this case, the UE maintains two independent variables VarMeasConfig and VarMeasReportList, one associated with each measConfig IE, and independently performs all the measurement procedures for each measConfig IE and the associated VarMeasConfig and VarMeasReportList variables, unless explicitly stated otherwise.

The configurations related to CBR measurements are only included in the measConfig IE associated with the MCG.

The configurations related to Rx-Tx time difference measurement are only included in the measConfig IE associated with the MCG.

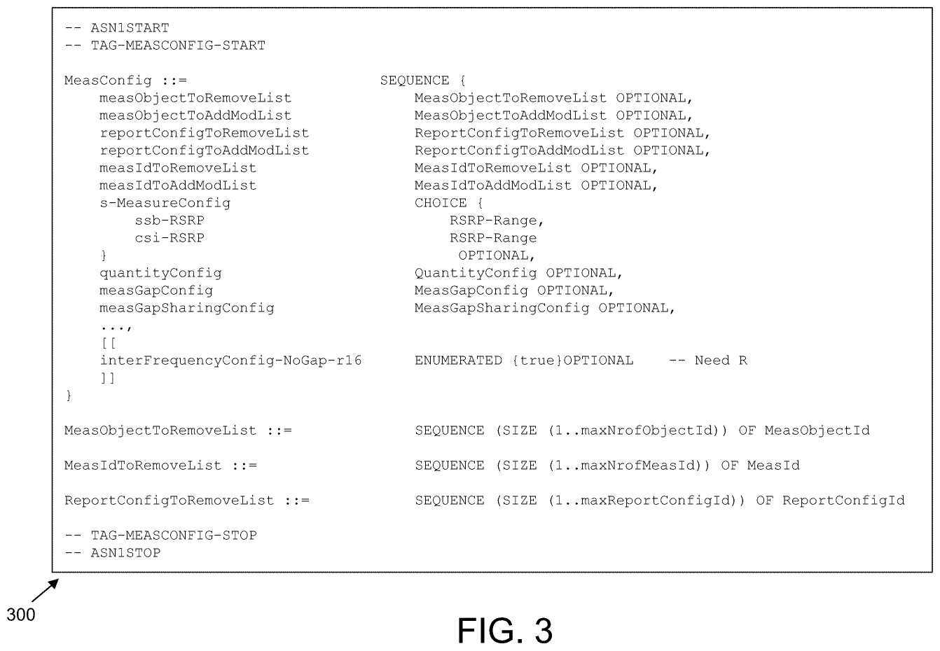

FIG. 3 illustrates an example of a measurement configuration 300, in accordance with aspects of the present disclosure. A serving radio cell (network) configures the UE for performing and reporting measurements. For this purpose, an RRC Reconfiguration message (i.e., RRCReconfiguration) is used in 5G NR system to carry a measurement configuration for a UE in an RRC connected (i.e., RRC_CONNECTED) state. Note that for a UE in an RRC inactive (i.e., RRC_INACTIVE) state, an RRC Resume message (i.e., RRCResume) may be used to carry a measurement configuration for the UE. The measurement configuration for the UE is contained in an IE called “MeasConfig”, exemplary contents of this are illustrated in FIG. 3.

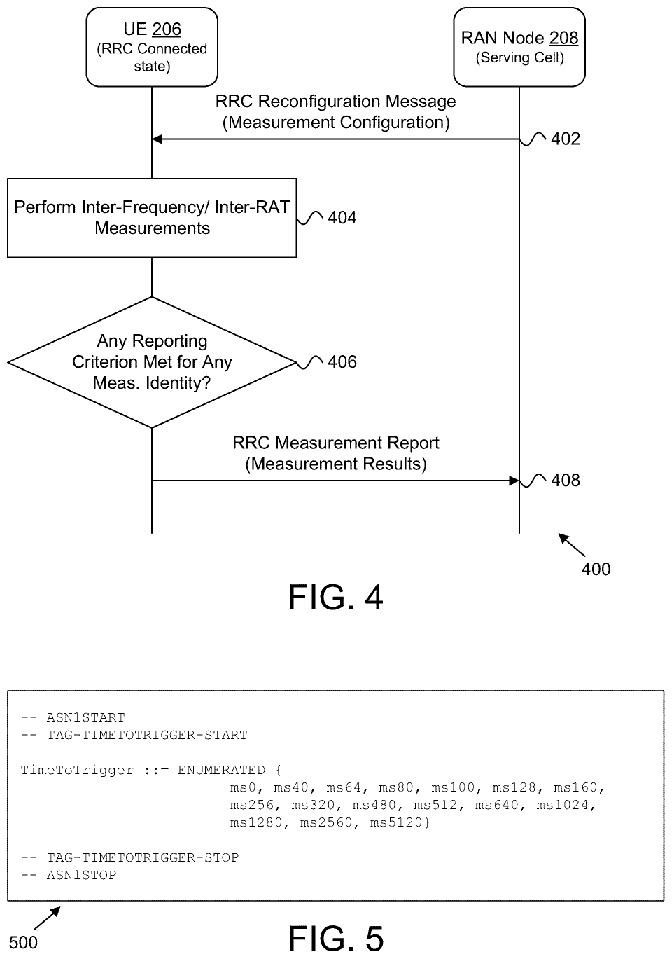

FIG. 4 illustrates an example of an NR measurement procedure 400, in accordance with aspects of the present disclosure. The NR measurement procedure 400 involves a RAN node 208 associated with a serving cell and a UE 206 in an RRC Connected state.

At Step 1, the RAN node 208 transmits a measurement configuration to the UE 206 (see signaling 402). In the NR measurement procedure 400, it is assumed that the UE 206 is in the RRC connected state, therefore the RAN node 208 may transmit an RRC Reconfiguration message containing the measurement configuration. However, in other embodiments, the RAN node 208 may transmit an RRC Resume message containing the measurement configuration.

At Step 2, upon receiving the measurement configuration, the UE 206 starts to perform measurements (see block 404). If the measurement configuration includes (i.e., refers to) more than one measurement object, then the UE may start inter-frequency measurements (including inter RAT measurements) in any order.

To facilitate inter-frequency measurements (including inter RAT measurements), the network (i.e., RAN node 208) may configure the UE 206 with a set of measurement gaps (i.e., included in the measurement configuration). During these measurement gaps, the UE 206 tunes its radio frequency (RF) receiver away from the current serving frequency to the frequency included in the corresponding measurement object and collect measurement samples of a reference signal (e.g., SSB, CSI-RS, etc.) of one or more particular cell(s) on that measurement object. In certain embodiments, the UE 206 may need to filter multiple of such measurement samples to assess the measurement radio quality of the said measurement object, of one or more particular cell(s) on that measurement object. This may require use of multiple measurement gap occasions as some L3 filtering to further stabilize measurements that can be used by the UE 206.

In some embodiments, different UE implementations may use different strategies in performing measurements. While some UE implementation may take samples of more than one measurement object (say on frequencies A, B and C) in one (or more) measurement gap(s), another UE implementation may take samples of one and the same measurement object (of say only frequency A) until an stable measurement (after L1 and L3 filtering) for the said measurement object is determined, after which this UE implementation shall move to the next measurement object (of say only frequency B) and so on.

At Step 3, the UE 206 determines whether any reporting criterion is met (i.e., satisfied) for any measurement identity (see decision block 406). Regardless of the strategy used to perform the measurements, once a measurement event is triggered for at least one measurement object, the UE 206 is to report this to the network using a RRC measurement report message. Accordingly, the UE 206 may generate a measurement report to inform the network about the measurement results associated with the satisfied reporting criterion. As used herein, a measurement event refers to an event-based reporting trigger caused by a reporting criterion being satisfied.

At Step 4, the UE 206 transmits a measurement report containing measurement results to the RAN node 208 (see messaging 408). However, if measurements and/or evaluation for another measurement identity are ongoing, there is a risk that the first triggered measurement report will not identify the best radio frequency or cell, and thus the RAN node 208 may unknowingly instruct the UE 206 to handover to an inferior radio frequency or cell. Accordingly, the UE 206 may enhance the measurement report and/or the measurement procedure according to one or more of the below solutions.

According to aspects of a first solution, when a measurement report is triggered due to a measurement event being satisfied for a first measurement object (e.g., in accordance with legacy UE behavior based on 3GPP TS 38.331), the UE 206 may include a new indication in the RRC Measurement Report message indicating if there are any ongoing measurement(s) in the UE. Upon receiving this indication, the radio network (i.e., RAN node 208) may decide to wait for another measurement report from the UE side, before deciding on UE handover according to the measurement results (e.g., event trigger) currently received. Waiting for a subsequent measurement report reduces the likelihood that the radio network will inadvertently select a sub-optimal radio frequency or cell for the UE handover. However, this “blind” wait may be wasteful and delay the handover decision if the other ongoing measurement(s) do not yield a suitable candidate, i.e., a candidate triggering a measurement event.

According to aspects of a second solution, the first solution may be expanded and enhanced by the UE 206 indicating whether the ongoing measurement(s) (i.e., associated with a second measurement object and/or measurement identity) are likely to trigger a measurement event. Here, when a measurement report is triggered due to a measurement event being satisfied for a first measurement object (e.g., in accordance with legacy UE behavior based on 3GPP TS 38.331), the UE 206 includes a new indication in the Measurement Report indicating if there are any ongoing measurement in the UE and also indicating whether the measurement sample(s) obtained so far suggest the preliminary measurement value(s) of one or more cells exceeding a certain threshold, configured by the radio network (i.e., RAN node 208).

In one embodiment, the Measurement Report comprises a combined indication (i.e., a single Boolean flag) that indicates both that there is at least one ongoing measurement in the UE 206 and that the preliminary evaluation of the radio quality of the measured radio frequency and/or cell satisfies the network-configured threshold. In another embodiment, the Measurement Report comprises a separate indications (i.e., distinct Boolean flags): a first indication to indicate that there is at least one ongoing measurement in the UE 206 and a second indication to indicate that the preliminary evaluation of the radio quality of the measured radio frequency and/or cell satisfies the network-configured threshold.

Upon receiving the indication(s), the radio network (i.e., RAN node 208) may decide to wait for another measurement report from the UE side, before deciding on UE handover according to the measurement results (e.g., event trigger) currently received.

According to aspects of a third solution, rather than reporting the first measurement report (even when a measurement report is triggered due to legacy UE behavior, e.g., a measurement event for a first measurement object is met) the UE 206 may wait (i.e., delay the measurement reporting) if there are any ongoing measurement (e.g., associated with another measurement object) and if the measurement sample(s) obtained for a second measurement object so far suggest the preliminary measurement value(s) of one or more cells exceeding a certain threshold corresponding to event entering condition, configured by the radio network (i.e., RAN node 208). If eventually, the second measurement object satisfies (i.e., meets) the measurement event, then the UE 206 reports both measurement objects together. This saves the UE 206 energy by not having to transmit two separate measurement reports.

On the other hand, if the second measurement object leaves the reporting condition, then the UE 206 report the firsts measurement object with latest measurement results available if there are no further measurement objects according to previously presented embodiments.

According to aspects of a fourth solution, the first solution, the second solution, and/or the third solution may be expanded and enhanced by the UE 206 using a timer whose value can be configured by the network (i.e., RAN node 208) to the UE 206, or it may be specified or left for UE implementation to select a reasonable value, e.g., a fraction of the RRC measurement parameter Time-to-trigger.

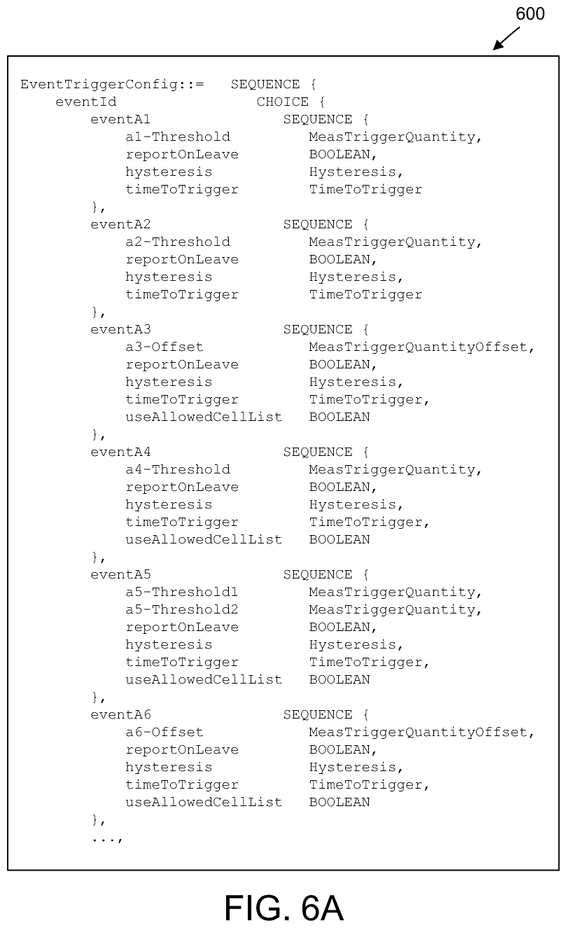

FIG. 5 illustrates an example of a RRC measurement parameter 500 Time-to-trigger enumerating TimeToTrigger values, in accordance with aspects of the disclosure.

In accordance with the first and second solutions, the new indication in the RRC Measurement Report message may be a Boolean flag and the UE 206 sets the Boolean flag only if the measurement and evaluation of at least one cell or measurement object will finish before the expiry of this timer. In such embodiments, the UE 206 may start the timer when a measurement report is triggered due to a measurement event being satisfied for at least one cell among the measurement objects configured by the network (e.g., in accordance with legacy UE behavior based on 3GPP TS 38.331).

Similarly, in accordance with the third solution, the UE 206 may wait for completion of an ongoing measurement and evaluation of at least one cell or measurement object only when the measurement and evaluation will finish before the expiry of this timer. In such embodiments, the UE 206 may start the timer when a measurement report is triggered due to a measurement event being satisfied for at least one cell among the measurement objects configured by the network (e.g., in accordance with legacy UE behavior based on 3GPP TS 38.331). Upon expiry of the timer, the UE 206 may transmit the RRC Measurement Report message.

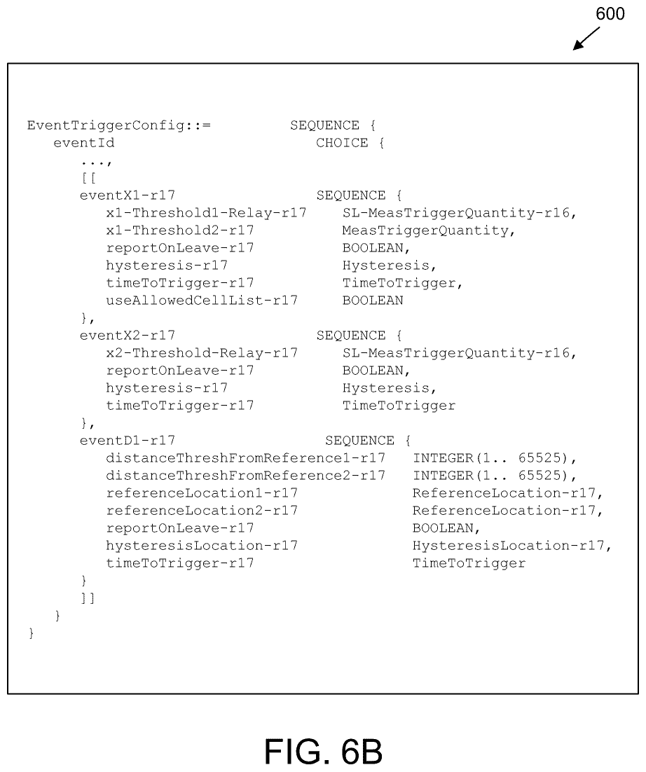

In various embodiments, the UE 206 may be configured by the network with multiple measurement events, including one or more of those shown in FIG. 6A and FIG. 6B.

FIGS. 6A-6B illustrate an example of an event trigger configuration 600 defining various measurement events, in accordance with aspects of the disclosure. A measurement event may be identified with an event identity (eventId). In some embodiments, the measurement event may be associated with a hysteresis parameter that defines half the difference between a trigger condition and a cancellation condition.

In certain embodiments, a respective measurement event may define at least one threshold (e.g., trigger quantity). For example, the measurement event may be triggered when the radio quality of the serving cell becomes better than the threshold. As another example, the measurement event may be triggered when the radio quality of the serving cell becomes worse than the threshold. In yet another example, the measurement event may be triggered when a radio quality of neighboring cell becomes better than the threshold. Where multiple thresholds are configured, the measurement event may be triggered when a radio quality of the serving cell becomes worse than a first threshold and the radio quality of a neighboring cell becomes better than a second threshold.

In certain embodiments, a respective measurement event may define at least one offset (e.g., trigger quantity offset) to apply to a measured cell. The offset may include a measurement object-specific offset, a cell-specific offset, or a combination thereof. For example, the measurement event may be triggered when the measurement result (plus offset) of a neighbor cell becomes better than the measurement result (plus offset) of the serving cell. As another example, the measurement event may be triggered when the measurement result (plus offset) of a neighbor cell becomes better than the measurement result (plus offset) of a secondary cell.

In another embodiment of the fourth solution, a timer is used by the radio network (i.e., RAN node 208) directly such that when it receives a measurement report from the UE 206 including a new indication in the RRC Measurement Report message, the radio network (i.e., RAN node 208) waits to receive a further measurement report from the UE 206 only until the expiry of this timer. If a new measurement report is indeed received from the UE 206, a handover decision is made based on the measurement reports received thus far. Otherwise, upon expiry of the timer, the radio network (i.e., RAN node 208) makes a handover decision based only on the measurement report(s) received before expiry of the timer.

In detail, after, transmitting RRC Connection Reconfiguration message containing a measurement configuration including a plurality of measurement identities, and receiving first RRC measurement report including an indication indicating that another measurement report from the UE may be expected, the radio network (i.e., RAN node 208) starts a timer upon reception of the measurement report including the indication (i.e., Boolean indication is SET). Additionally, the radio network (i.e., RAN node 208) stops the timer and makes the handover decision based on the available measurement reports if a new measurement report that does not contain the new indication (i.e., Boolean indication is not SET) is received. Else, the radio network (i.e., RAN node 208) makes the handover decision based on the available measurement reports at the expiry of the said timer.

In one implementation, the new timer is reset each time the network receives a Measurement report wherein the said Boolean is SET. To prevent undue delay in making the handover decision, a Maximum count or a supervising timer can be used to contain cases for when the new timer is reset each time the network receives a Measurement report wherein the said Boolean is SET.

In another implementation, the new timer is not reset each time the network receives a Measurement report wherein the said Boolean is SET, allowing a quicker handover decision which could be critical if the UE's serving radio quality is deteriorating fast.

According to embodiments aspects of a fifth solution, the UE 206 may send one or more of the following information to the network in a RRC measurement report message: 1) A list of not-yet-measured measurement objects and/or measurement identities; 2) A list of measurement objects and/or measurement identities for which measurement and/or evaluation is ongoing; 3) A list of measurement objects and/or measurement identities which the UE does not want to measure (e.g., does not intend to measure); 4) A list of measurement objects and/or measurement identities which the UE still wants to measure (e.g., still intends to measure) based on its service or slice priority; 5) The order in which measurement objects and/or measurement identities will be measured and/or evaluated in the UE; and/or 6) A remaining time to finish an ongoing measurement and/or evaluation.

Note that the slice priority may be indicated by network slice selection assistance information (NSSAI). A network slice instance may be identified by a single-network slice selection assistance information (S-NSSAI) while a set of network slices for which the UE 104 is authorized to use is identified by the NSSAI. Here, NSSAI refers to a vector value including one or more S-NSSAI values. In certain embodiments, the various network slices may include separate instances of network functions, such as the session management function (SMF) and UPF.

Upon reception of the RRC measurement report message, the radio network (i.e., RAN node 208) may use this additional information to decide if it should wait for another measurement report from the UE 206, or just make the handover decision based on the measurement reports received thus far.

In one implementation of the fifth solution, based on one or more of the above information received by the network, the radio network (i.e., RAN node 208) may send another measurement reconfiguration to the UE 206. In some embodiments, this additional measurement reconfiguration may include a list of measurement objects and/or measurement identities that should be used by the UE 206 in strict order, i.e., starting with the first measurement object and/or measurement identity appearing in the list, to carry out the measurements and measurement evaluation.

In all the above solutions, the UE 206 strives to include the latest radio measurement values (e.g., RSRP/RSRQ) for reported cells as much as possible for the previously reported cells as well.

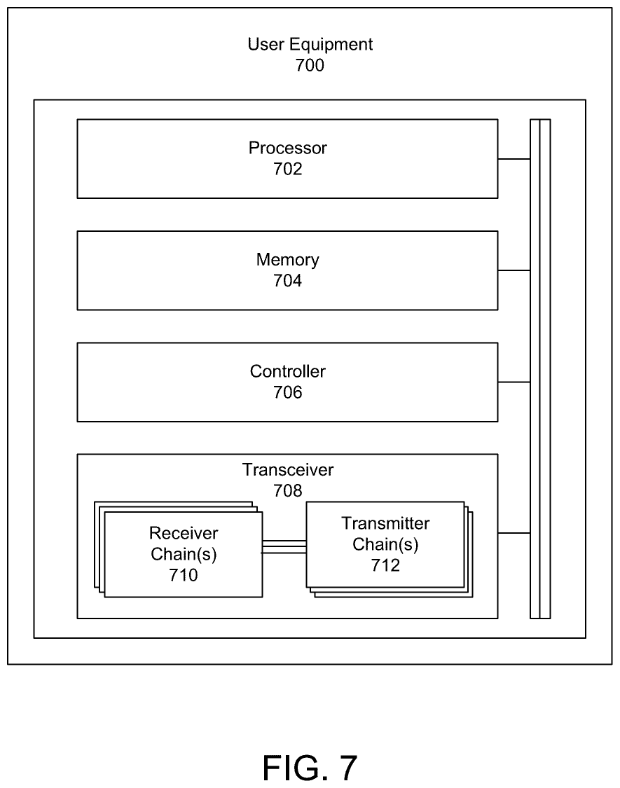

FIG. 7 illustrates an example of a UE 700 in accordance with aspects of the present disclosure. The UE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a central processing unit (CPU), an ASIC, a field programmable gate array (FPGA), or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the UE 700 to perform various functions of the present disclosure.

The memory 704 may include volatile or non-volatile memory. The memory 704 may store computer-readable, computer-executable code including instructions that, when executed by the processor 702, cause the UE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the UE 700 to perform one or more of the functions described herein (e.g., executing, by the processor 702, instructions stored in the memory 704). For example, the processor 702 may support wireless communication at the UE 700 in accordance with examples as disclosed herein.

In various implementations, the UE 700 may be configured to support a means for receiving a first message including a measurement configuration, where the measurement configuration includes a plurality of measurement identities. In some implementations, the first message is received from a RAN. In some implementations, the first message includes an RRC reconfiguration message or an RRC resume message.

In some implementations, the measurement configuration further includes a plurality of measurement objects, where each of the plurality of measurement identities corresponds to one of the plurality of measurement objects. In certain implementations, each of the plurality of measurement objects corresponds to a radio frequency and/or a cell. In certain implementations, the measurement configuration further includes a measurement event associated with at least one measurement object.

The UE 700 may be configured to support a means for determining, based on measurements associated with at least a first measurement identity in the plurality of measurement identities, that a measurement reporting criterion for at least one cell is satisfied while a measurement or a measurement evaluation associated with a second measurement identity is ongoing. In some implementations, to determine that the measurement reporting criterion for the at least one cell is satisfied, the UE 700 may be configured to support a means for determining that the measurement event is triggered.

In some implementations, the UE 700 may be further configured to support a means for performing inter-frequency measurements for a list of measurement objects. In such implementations, to determine that the measurement reporting criterion for the at least one cell is satisfied, the UE 700 may be configured to support a means for evaluating the inter-frequency measurements associated with at least the first measurement identity.

The UE 700 may be configured to support a means for generating a measurement report based on the measurements associated with at least a first measurement identity and for adding, to the measurement report, an indication that another measurement is in progress. In some implementations, the indication includes a Boolean flag.

In some implementations, the UE 700 may be further configured to support a means for determining whether a radio quality of a respective cell (e.g., associated with the second measurement identity) satisfies a radio threshold. In such implementations, the indication that another measurement is in progress may further indicate that the radio quality of the respective cell satisfies the preliminary radio threshold. In other implementations, the UE 700 may be further configured to support a means for adding, to the measurement report, a second indication that the radio quality of the respective cell satisfies the preliminary radio threshold.

In certain implementations, the preliminary radio threshold corresponds to an event entering radio condition. In one implementation, the preliminary radio threshold corresponds to an RSRP value configured by the RAN. In another implementation, the radio threshold corresponds to an RSRQ value configured by the RAN.

In some implementations, the UE 700 may be further configured to support a means for determining whether the measurement evaluation associated with the second measurement identity will complete within a predetermined time. In such implementations, to add the indication to the measurement report, the UE 700 may be configured with means for adding the indication based on the measurement evaluation associated with the second measurement identity completing within the predetermined time. In certain implementations, the predetermined time corresponds to a network-configured timer value. In certain implementations, the predetermined time is based on a time-to-trigger parameter associated with a measurement event.

The UE 700 may be configured to support a means for transmitting a second message including the measurement report. In some implementations, the second message includes an RRC measurement report message.

In some implementations, the measurement report further includes one or more of: 1) a set of unmeasured measurement objects; 2) a set of unmeasured measurement identities; 3) a set of measurement objects for which measurement and evaluation is ongoing; 4) a set of measurement identities for which measurement and evaluation is ongoing; 5) a set of unmeasured measurement objects for which measurement and evaluation is undesired; 6) a set of unmeasured measurement identities for which measurement and evaluation is undesired; 7) a set of unmeasured measurement objects for which measurement and evaluation is desired based on a service priority or a network slice priority; 8) a set of unmeasured measurement identities for which measurement and evaluation is desired based on a service priority or a network slice priority; 9) an order in which a set of unmeasured measurement objects is to be measured and evaluated; 10) an order in which a set of unmeasured measurement identities objects is to be measured and evaluated; 11) a remaining time to complete an ongoing measurement and evaluation associated with the second measurement identity; or 12) a combination thereof. In further implementations, the UE 700 may be further configured to support means for receiving a third message including an ordered list of measurement objects or measurement identities for measurement and evaluation.

In various embodiments, the UE 700 may be configured to support a means for delaying measurement reporting associated with the first measurement identity in response to a radio quality of a respective cell corresponding to the second measurement identity satisfying a radio threshold. In some implementations, the radio threshold corresponds to an RSRP value or an RSRQ value.

The UE 700 may be configured to support a means for generating a combined measurement report in response to a completion of the measurement evaluation associated with the second measurement identity and in response to measurements associated with the second measurement identity satisfying a second measurement reporting criterion. In some implementations, the UE 700 may be further configured to support a means for generating a single measurement report in response to the radio quality of the respective cell corresponding to the second measurement identity not satisfying the radio threshold or in response to the measurements associated with the second measurement identity not satisfying the second measurement reporting criterion.

In some implementations, the UE 700 may be further configured to support a means for determining whether the measurement evaluation associated with the second measurement identity will complete within a predetermined time. In such implementations, the UE 700 may be configured to support a means for generating the combined measurement report further in response to the measurement evaluation associated with the second measurement identity completing within the predetermined time. In certain implementations, the predetermined time corresponds to a network-configured timer value. In certain implementations, the predetermined time is based on a time-to-trigger parameter associated with a measurement event. In further implementations, the UE 700 may be further configured to support a means for generating a single measurement report in response to the measurement evaluation associated with the second measurement identity not completing within the predetermined time.

The UE 700 may be configured to support a means for transmitting a second message including the combined measurement report, wherein the combined measurement report is based on the measurements associated with at least a first measurement identity and based on the measurements associated with the second measurement identity.

The controller 706 may manage input and output signals for the UE 700. The controller 706 may also manage peripherals not integrated into the UE 700. In some implementations, the controller 706 may utilize an operating system (OS) such as iOS®, ANDROID®, WINDOWS®, or other operating systems. In some implementations, the controller 706 may be implemented as part of the processor 702.

In some implementations, the UE 700 may include at least one transceiver 708. In some other implementations, the UE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receiving the signal over the air or wireless medium. The receiver chain 710 may include at least one amplifier (e.g., a low-noise amplifier (LNA)) configured to amplify the received signal. The receiver chain 710 may include at least one demodulator configured to demodulate the received signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

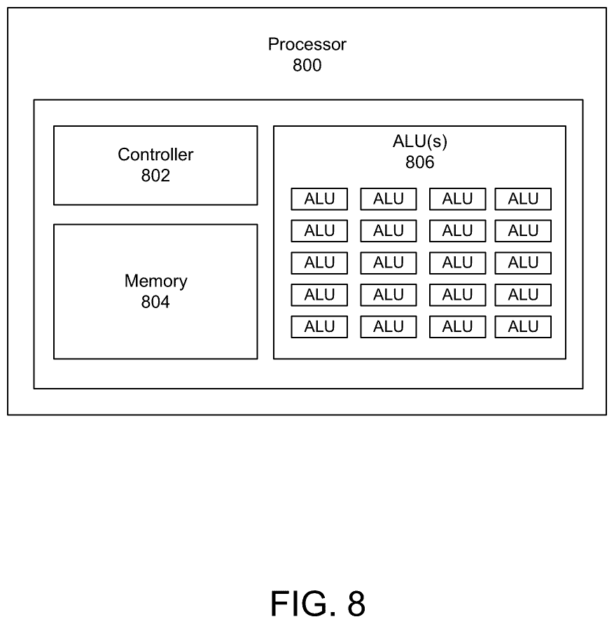

FIG. 8 illustrates an example of a processor 800 in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, which may be, for example, an L1/L2/L3 cache. Additionally, or alternatively, the processor 800 may optionally include one or more arithmetic-logic units (ALUs) 806. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory address of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, arithmetic logic units (ALUs), and other functional units of the processor 800.

The memory 804 may include one or more caches (e.g., memory local to or included in the processor 800 or other memory, such RAM, ROM, DRAM, SDRAM, SRAM, MRAM, flash memory, etc. In some implementations, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, the processor 800, the controller 802, and the memory 804 may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 806 may be configured to support various operations in accordance with examples as described herein. In some implementations, the one or more ALUs 806 may reside within or on a processor chipset (e.g., the processor 800). In some other implementations, the one or more ALUs 806 may reside external to the processor chipset (e.g., the processor 800). One or more ALUs 806 may perform one or more computations such as addition, subtraction, multiplication, and division on data. For example, one or more ALUs 806 may receive input operands and an operation code, which determines an operation to be executed. One or more ALUs 806 be configured with a variety of logical and arithmetic circuits, including adders, subtractors, shifters, and logic gates, to process and manipulate the data according to the operation. Additionally, or alternatively, the one or more ALUs 806 may support logical operations such as AND, OR, exclusive-OR (XOR), not-OR (NOR), and not-AND (NAND), enabling the one or more ALUs 806 to handle conditional operations, comparisons, and bitwise operations.

The processor 800 may support wireless communication in accordance with examples as disclosed herein. The processor 800 may be configured to or operable to support a means for receiving a first message including a measurement configuration, where the measurement configuration includes a plurality of measurement identities. In some implementations, the first message is received from a RAN. In some implementations, the first message includes an RRC reconfiguration message or an RRC resume message.

In some implementations, the measurement configuration further includes a plurality of measurement objects, where each of the plurality of measurement identities corresponds to one of the plurality of measurement objects. In certain implementations, each of the plurality of measurement objects corresponds to a radio frequency and/or a cell. In certain implementations, the measurement configuration further includes a measurement event associated with at least one measurement object.

The processor 800 may be configured to support a means for determining, based on measurements associated with at least a first measurement identity in the plurality of measurement identities, that a measurement reporting criterion for at least one cell is satisfied while a measurement or a measurement evaluation associated with a second measurement identity is ongoing. In some implementations, to determine that the measurement reporting criterion for the at least one cell is satisfied, the processor 800 may be configured to support a means for determining that the measurement event is triggered.

In some implementations, the processor 800 may be further configured to support a means for performing inter-frequency measurements for a list of measurement objects. In such implementations, to determine that the measurement reporting criterion for the at least one cell is satisfied, the processor 800 may be configured to support a means for evaluating the inter-frequency measurements associated with at least the first measurement identity.

The processor 800 may be configured to support a means for generating a measurement report based on the measurements associated with at least a first measurement identity and for adding, to the measurement report, an indication that another measurement is in progress. In some implementations, the indication includes a Boolean flag.

In some implementations, the processor 800 may be further configured to support a means for determining whether a radio quality of a respective cell (e.g., associated with the second measurement identity) satisfies a radio threshold. In such implementations, the indication that another measurement is in progress may further indicate that the radio quality of the respective cell satisfies the preliminary radio threshold. In other implementations, the processor 800 may be further configured to support a means for adding, to the measurement report, a second indication that the radio quality of the respective cell satisfies the preliminary radio threshold.

In certain implementations, the preliminary radio threshold corresponds to an event entering radio condition. In one implementation, the preliminary radio threshold corresponds to an RSRP value configured by the RAN. In another implementation, the radio threshold corresponds to an RSRQ value configured by the RAN.

In some implementations, the processor 800 may be further configured to support a means for determining whether the measurement evaluation associated with the second measurement identity will complete within a predetermined time. In such implementations, to add the indication to the measurement report, the processor 800 may be configured with means for adding the indication based on the measurement evaluation associated with the second measurement identity completing within the predetermined time. In certain implementations, the predetermined time corresponds to a network-configured timer value. In certain implementations, the predetermined time is based on a time-to-trigger parameter associated with a measurement event.

The processor 800 may be configured to support a means for transmitting a second message including the measurement report. In some implementations, the second message includes an RRC measurement report message.

In some implementations, the measurement report further includes one or more of: 1) a set of unmeasured measurement objects; 2) a set of unmeasured measurement identities; 3) a set of measurement objects for which measurement and evaluation is ongoing; 4) a set of measurement identities for which measurement and evaluation is ongoing; 5) a set of unmeasured measurement objects for which measurement and evaluation is undesired; 6) a set of unmeasured measurement identities for which measurement and evaluation is undesired; 7) a set of unmeasured measurement objects for which measurement and evaluation is desired based on a service priority or a network slice priority; 8) a set of unmeasured measurement identities for which measurement and evaluation is desired based on a service priority or a network slice priority; 9) an order in which a set of unmeasured measurement objects is to be measured and evaluated; 10) an order in which a set of unmeasured measurement identities objects is to be measured and evaluated; 11) a remaining time to complete an ongoing measurement and evaluation associated with the second measurement identity; or 12) a combination thereof. In further implementations, the processor 800 may be further configured to support means for receiving a third message including an ordered list of measurement objects or measurement identities for measurement and evaluation.

In various embodiments, the processor 800 may be configured to support a means for delaying measurement reporting associated with the first measurement identity in response to a radio quality of a respective cell corresponding to the second measurement identity satisfying a radio threshold. In some implementations, the radio threshold corresponds to an RSRP value or an RSRQ value.

The processor 800 may be configured to support a means for generating a combined measurement report in response to a completion of the measurement evaluation associated with the second measurement identity and in response to measurements associated with the second measurement identity satisfying a second measurement reporting criterion. In some implementations, the processor 800 may be further configured to support a means for generating a single measurement report in response to the radio quality of the respective cell corresponding to the second measurement identity not satisfying the radio threshold or in response to the measurements associated with the second measurement identity not satisfying the second measurement reporting criterion.

In some implementations, the processor 800 may be further configured to support a means for determining whether the measurement evaluation associated with the second measurement identity will complete within a predetermined time. In such implementations, the processor 800 may be configured to support a means for generating the combined measurement report further in response to the measurement evaluation associated with the second measurement identity completing within the predetermined time. In certain implementations, the predetermined time corresponds to a network-configured timer value. In certain implementations, the predetermined time is based on a time-to-trigger parameter associated with a measurement event. In further implementations, the processor 800 may be further configured to support a means for generating a single measurement report in response to the measurement evaluation associated with the second measurement identity not completing within the predetermined time.

The processor 800 may be configured to support a means for transmitting a second message including the combined measurement report, wherein the combined measurement report is based on the measurements associated with at least a first measurement identity and based on the measurements associated with the second measurement identity.

In various implementations, the processor 800 may support wireless communication at a base station in accordance with examples as disclosed herein. The processor 800 may be configured to or operable to support a means for transmitting, to a UE, a first message including a measurement configuration, where the measurement configuration includes a plurality of measurement identities. In some implementations, the first message includes an RRC reconfiguration message or an RRC resume message.

In some implementations, the measurement configuration further includes a plurality of measurement objects, where each of the plurality of measurement identities corresponds to one of the plurality of measurement objects. In certain implementations, each of the plurality of measurement objects corresponds to a radio frequency or a cell. In certain implementations, the measurement configuration further includes a measurement event associated with at least one measurement object.

The processor 800 may be configured to or operable to support a means for receiving, from the UE, a first measurement report based on measurements associated with at least a first measurement identity in the plurality of measurement identities, where the first measurement report further includes an indication that another measurement is in progress and a radio quality of an associated cell satisfies a preliminary radio threshold. In some implementations, the measurement report includes an RRC measurement report message. In some implementations, the indication that another measurement is in progress includes a Boolean flag.

In some implementations, the processor 800 may be configured to or operable to support a means for provisioning the UE with a radio threshold for preliminary evaluation of a radio quality of a respective cell corresponding to the second measurement identity, where the indication that another measurement is in progress further indicates that the radio quality of the respective cell satisfies the radio threshold. In certain implementations, the radio threshold corresponds to an RSRP value or an RSRQ value.

In some implementations, the first measurement report further includes one or more of: 1) a set of unmeasured measurement objects; 2) a set of unmeasured measurement identities; 3) a set of measurement objects for which measurement and evaluation is ongoing; 4) a set of measurement identities for which measurement and evaluation is ongoing; 5) a set of unmeasured measurement objects for which measurement and evaluation is undesired; 6) a set of unmeasured measurement identities for which measurement and evaluation is undesired; 7) a set of unmeasured measurement objects for which measurement and evaluation is desired based on a service priority or a network slice priority; 8) a set of unmeasured measurement identities for which measurement and evaluation is desired based on a service priority or a network slice priority; 9) an order in which a set of unmeasured measurement objects is to be measured and evaluated; 10) an order in which a set of unmeasured measurement identities objects is to be measured and evaluated; 11) a remaining time to complete an ongoing measurement and evaluation associated with the second measurement identity; or 12) a combination thereof. In further implementations, the processor 800 may be further configured to support means for transmitting a second message including an ordered list of measurement objects or measurement identities for measurement and evaluation by the UE.

The processor 800 may be configured to or operable to support a means for starting a timer upon reception of the first measurement report. In some implementations, the processor 800 may be configured to or operable to support a means for resetting the timer in response to receiving a second measurement report that includes the indication that another measurement is in progress. In certain implementations, the processor 800 may be configured to or operable to support a means for stopping the resetting of the timer in response to a maximum reset count being reached. In certain implementations, the processor 800 may be configured to or operable to support a means for starting a supervisory timer upon reception of the first measurement report and a means for stopping resetting the timer in response to expiry of the supervisory timer.

The processor 800 may be configured to or operable to support a means for determining whether one or more second measurement reports are received from the UE prior to expiry of the timer, where the one or more second measurement reports are based on measurements associated with at least a second measurement identity in the plurality of measurement identities.

The processor 800 may be configured to or operable to support a means for performing a handover decision for the UE based at least in part on the first measurement report, where the handover decision is further based on the one or more second measurement reports in response to the one or more second measurement reports being received from the UE prior to expiry of the timer.

In some implementations, the processor 800 may be further configured to or operable to support a means for performing the handover decision prior to expiry of the timer in response to receiving a second measurement report that lacks the indication that another measurement is in progress. The processor 800 may be configured to or operable to support a means for transmitting an indication of the handover decision to the UE.

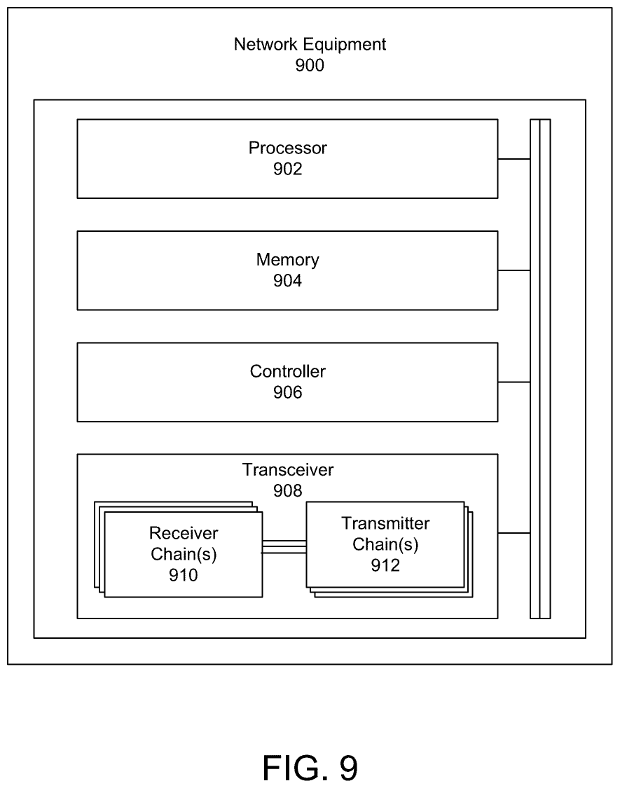

FIG. 9 illustrates an example of a NE 900 in accordance with aspects of the present disclosure. The NE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the NE 900 to perform various functions of the present disclosure.

The memory 904 may include volatile or non-volatile memory. The memory 904 may store computer-readable, computer-executable code including instructions when executed by the processor 902 cause the NE 900 to perform various functions described herein. The code may be stored in a non-transitory computer-readable medium such the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the NE 900 to perform one or more of the functions described herein (e.g., executing, by the processor 902, instructions stored in the memory 904). For example, the processor 902 may support wireless communication at the NE 900 in accordance with examples as disclosed herein.

In various implementations, the NE 900 may be configured to support a means for transmitting, to a UE, a first message including a measurement configuration, where the measurement configuration includes a plurality of measurement identities. In some implementations, the first message includes an RRC reconfiguration message or an RRC resume message.

In some implementations, the measurement configuration further includes a plurality of measurement objects, where each of the plurality of measurement identities corresponds to one of the plurality of measurement objects. In certain implementations, each of the plurality of measurement objects corresponds to a radio frequency or a cell. In certain implementations, the measurement configuration further includes a measurement event associated with at least one measurement object.

The NE 900 may be configured to support a means for receiving, from the UE, a first measurement report based on measurements associated with at least a first measurement identity in the plurality of measurement identities, where the first measurement report further includes an indication that another measurement is in progress and a radio quality of an associated cell satisfies a preliminary radio threshold. In some implementations, the measurement report includes an RRC measurement report message. In some implementations, the indication that another measurement is in progress includes a Boolean flag.

In some implementations, the NE 900 may be configured to support a means for provisioning the UE with a radio threshold for preliminary evaluation of a radio quality of a respective cell corresponding to the second measurement identity, where the indication that another measurement is in progress further indicates that the radio quality of the respective cell satisfies the radio threshold. In certain implementations, the radio threshold corresponds to an RSRP value or an RSRQ value.

In some implementations, the first measurement report further includes one or more of: 1) a set of unmeasured measurement objects; 2) a set of unmeasured measurement identities; 3) a set of measurement objects for which measurement and evaluation is ongoing; 4) a set of measurement identities for which measurement and evaluation is ongoing; 5) a set of unmeasured measurement objects for which measurement and evaluation is undesired; 6) a set of unmeasured measurement identities for which measurement and evaluation is undesired; 7) a set of unmeasured measurement objects for which measurement and evaluation is desired based on a service priority or a network slice priority; 8) a set of unmeasured measurement identities for which measurement and evaluation is desired based on a service priority or a network slice priority; 9) an order in which a set of unmeasured measurement objects is to be measured and evaluated; 10) an order in which a set of unmeasured measurement identities objects is to be measured and evaluated; 11) a remaining time to complete an ongoing measurement and evaluation associated with the second measurement identity; or 12) a combination thereof. In further implementations, the NE 900 may be further configured to support means for transmitting a second message including an ordered list of measurement objects or measurement identities for measurement and evaluation by the UE.

The NE 900 may be configured to support a means for starting a timer upon reception of the first measurement report. In some implementations, the NE 900 may be configured to support a means for resetting the timer in response to receiving a second measurement report that includes the indication that another measurement is in progress. In certain implementations, the NE 900 may be configured to support a means for stopping the resetting of the timer in response to a maximum reset count being reached. In certain implementations, the NE 900 may be configured to support a means for starting a supervisory timer upon reception of the first measurement report and a means for stopping resetting the timer in response to expiry of the supervisory timer.

The NE 900 may be configured to support a means for determining whether one or more second measurement reports are received from the UE prior to expiry of the timer, where the one or more second measurement reports are based on measurements associated with at least a second measurement identity in the plurality of measurement identities.

The NE 900 may be configured to support a means for performing a handover decision for the UE based at least in part on the first measurement report, where the handover decision is further based on the one or more second measurement reports in response to the one or more second measurement reports being received from the UE prior to expiry of the timer.

In some implementations, the NE 900 may be further configured to support a means for performing the handover decision prior to expiry of the timer in response to receiving a second measurement report that lacks the indication that another measurement is in progress. The NE 900 may be configured to support a means for transmitting an indication of the handover decision to the UE.

The controller 906 may manage input and output signals for the NE 900. The controller 906 may also manage peripherals not integrated into the NE 900. In some implementations, the controller 906 may utilize an operating system such as iOS®, ANDROID®, WINDOWS®, or other operating systems. In some implementations, the controller 906 may be implemented as part of the processor 902.

In some implementations, the NE 900 may include at least one transceiver 908. In some other implementations, the NE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas for receiving the signal over the air or wireless medium. The receiver chain 910 may include at least one amplifier (e.g., a low-noise amplifier (LNA)) configured to amplify the received signal. The receiver chain 910 may include at least one demodulator configured to demodulate the received signal and obtain the transmitted data by reversing the modulation technique applied during transmission of the signal. The receiver chain 910 may include at least one decoder for decoding the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

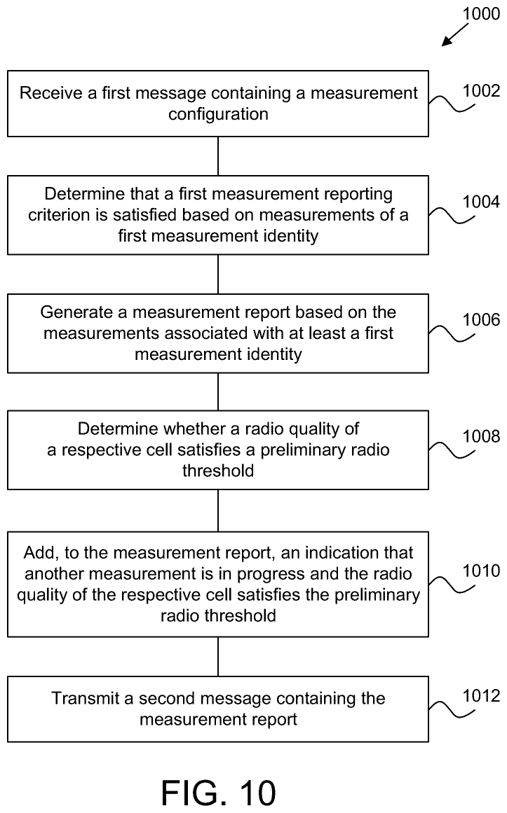

FIG. 10 illustrates a flowchart of a method 1000 in accordance with aspects of the present disclosure. The operations of the method 1000 may be implemented by a UE as described herein. In some implementations, the UE may execute a set of instructions to control the function elements of the UE to perform the described functions.

At step 1002, the method 1000 may include receiving a first message containing a measurement configuration, wherein the measurement configuration includes a plurality of measurement identities. The operations of step 1002 may be performed in accordance with examples as described herein. In some implementations, aspects of the operations of step 1002 may be performed by a UE as described with reference to FIG. 7.

At step 1004, the method 1000 may include determining, based on measurements associated with at least a first measurement identity in the plurality of measurement identities, that a measurement reporting criterion for at least one cell is satisfied, wherein a measurement or a measurement evaluation associated with a second measurement identity is ongoing. The operations of step 1004 may be performed in accordance with examples as described herein. In some implementations, aspects of the operations of step 1004 may be performed by a UE as described with reference to FIG. 7.

At step 1006, the method 1000 may include generating a measurement report based on the measurements associated with at least a first measurement identity. The operations of step 1006 may be performed in accordance with examples as described herein. In some implementations, aspects of the operations of step 1006 may be performed a UE as described with reference to FIG. 7.

At step 1008, the method 1000 may include determining whether a radio quality of a respective cell satisfies a preliminary radio threshold. The operations of step 1008 may be performed in accordance with examples as described herein. In some implementations, aspects of the operations of step 1008 may be performed by a UE as described with reference to FIG. 7.

At step 1010, the method 1000 may include adding, to the measurement report, an indication that another measurement is in progress and the radio quality of the respective cell satisfies the preliminary radio threshold. The operations of step 1010 may be performed in accordance with examples as described herein. In some implementations, aspects of the operations of step 1010 may be performed a UE as described with reference to FIG. 7.

At step 1012, the method 1000 may include transmitting a second message containing the measurement report. The operations of step 1012 may be performed in accordance with examples as described herein. In some implementations, aspects of the operations of step 1012 may be performed a UE as described with reference to FIG. 7.

It should be noted that the method 1000 described herein describes a possible implementation, and that the operations and the steps may be rearranged or otherwise modified and that other implementations are possible.

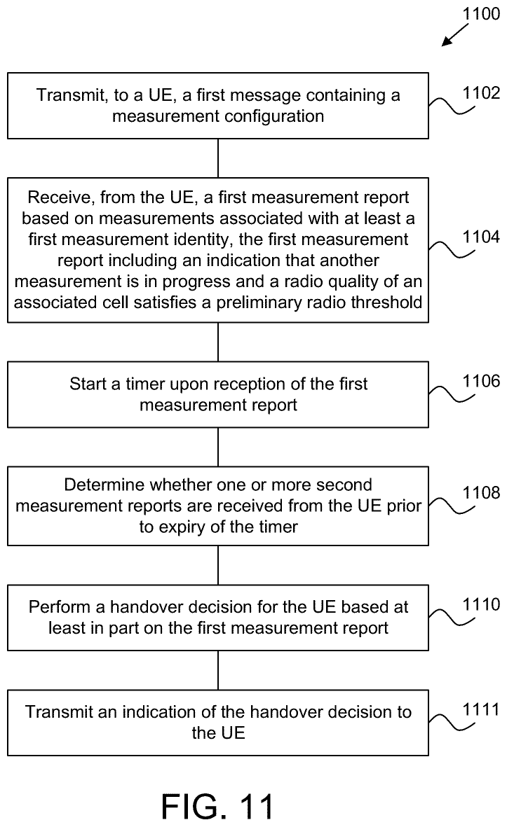

FIG. 11 illustrates a flowchart of a method 1100 in accordance with aspects of the present disclosure. The operations of the method 1100 may be implemented by a NE as described herein. In some implementations, the NE may execute a set of instructions to control the function elements of the NE to perform the described functions.

At step 1102, the method 1100 may include transmitting, to a UE, a first message containing a measurement configuration, where the measurement configuration includes a plurality of measurement identities. The operations of step 1102 may be performed in accordance with examples as described herein. In some implementations, aspects of the operations of step 1102 may be performed by a NE as described with reference to FIG. 9.

At step 1104, the method 1100 may include receiving, from the UE, a first measurement report based on measurements associated with at least a first measurement identity in the plurality of measurement identities. Here, the first measurement report further includes an indication that another measurement is in progress and a radio quality of an associated cell satisfies a preliminary radio threshold. The operations of step 1104 may be performed in accordance with examples as described herein. In some implementations, aspects of the operations of step 1104 may be performed by a NE as described with reference to FIG. 9.

At step 1106, the method 1100 may include starting a timer upon reception of the first measurement report. The operations of step 1106 may be performed in accordance with examples as described herein. In some implementations, aspects of the operations of step 1106 may be performed a NE as described with reference to FIG. 9.

At step 1108, the method 1100 may include determining whether one or more second measurement reports are received from the UE prior to expiry of the timer, where the one or more second measurement reports are based on measurements associated with at least a second measurement identity in the plurality of measurement identities. The operations of step 1108 may be performed in accordance with examples as described herein. In some implementations, aspects of the operations of step 1108 may be performed by a NE as described with reference to FIG. 9.

At step 1110, the method 1100 may include performing a handover decision for the UE based at least in part on the first measurement report. Here, the handover decision is further based on the one or more second measurement reports in response to the one or more second measurement reports being received from the UE prior to expiry of the timer. The operations of step 1110 may be performed in accordance with examples as described herein. In some implementations, aspects of the operations of step 1110 may be performed a NE as described with reference to FIG. 9.

At step 1112, the method 1100 may include transmitting an indication of the handover decision to the UE. The operations of step 1112 may be performed in accordance with examples as described herein. In some implementations, aspects of the operations of step 1112 may be performed a NE as described with reference to FIG. 9.

It should be noted that the method 1100 described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a first message comprising a measurement configuration, wherein the measurement configuration comprises a plurality of measurement identities;
determine, based on measurements associated with at least a first measurement identity in the plurality of measurement identities, that a measurement reporting criterion for at least one cell is satisfied, wherein a measurement or a measurement evaluation associated with a second measurement identity is ongoing;
determine whether a radio quality of a respective cell satisfies a preliminary radio threshold;
generate a measurement report based on the measurements associated with at least the first measurement identity;
add, to the measurement report, an indication that another measurement is in progress and the radio quality of the respective cell satisfies the preliminary radio threshold; and
transmit a second message comprising the measurement report.

2. The UE of claim 1, where the preliminary threshold corresponds to an event entering radio condition.

3. The UE of claim 1, wherein the first message is received from a radio access network (RAN), and wherein the preliminary radio threshold corresponds to a Reference Signal Receive Power (RSRP) value or a Reference Signal Receive Quality (RSRQ) value configured by the RAN.

4. The UE of claim 1, wherein the at least one processor is further configured to cause the UE to perform inter-frequency measurements for a list of measurement objects, and wherein to determine that the measurement reporting criterion for the at least one cell is satisfied, the at least one processor is configured to cause the UE to evaluate the inter-frequency measurements associated with at least the first measurement identity.

5. The UE of claim 1, wherein the measurement configuration further comprises a plurality of measurement objects, wherein each measurement object of the plurality of measurement objects corresponds to a radio frequency, and wherein each measurement identity of the plurality of measurement identities corresponds to a measurement object of the plurality of measurement objects.

6. The UE of claim 5, wherein the measurement configuration further comprises a measurement event associated with at least one measurement object, and wherein to determine that the measurement reporting criterion for the at least one cell is satisfied, the at least one processor is configured to cause the UE to determine that the measurement event is triggered.

7. The UE of claim 1, wherein the first message comprises a Radio Resource Control (RRC) reconfiguration message or an RRC resume message, and wherein the second message comprises an RRC measurement report message.

8. The UE of claim 1, wherein the at least one processor is further configured to cause the UE to determine whether the measurement evaluation associated with the second measurement identity will complete within a predetermined time, and wherein to add the indication to the measurement report, the at least one processor is configured to cause the UE to add the indication based on the measurement evaluation associated with the second measurement identity completing within the predetermined time.

9. The UE of claim 1, wherein the indication that another measurement is in progress comprises a Boolean flag.

10. The UE of claim 1, wherein the measurement report further comprises one or more of:
a set of unmeasured measurement objects;
a set of unmeasured measurement identities;
a set of measurement objects for which measurement and evaluation is ongoing;
a set of measurement identities for which measurement and evaluation is ongoing;
a set of unmeasured measurement objects for which measurement and evaluation is undesired;
a set of unmeasured measurement identities for which measurement and evaluation is undesired;
a set of unmeasured measurement objects for which measurement and evaluation is desired based on a service priority or a network slice priority;
a set of unmeasured measurement identities for which measurement and evaluation is desired based on a service priority or a network slice priority;
an order in which a set of unmeasured measurement objects is to be measured and evaluated;
an order in which a set of unmeasured measurement identities objects is to be measured and evaluated;
a remaining time to complete an ongoing measurement and evaluation associated with the second measurement identity;
or a combination thereof.

11. The UE of claim 10, wherein the at least one processor is further configured to cause the UE to receive a third message comprising an ordered list of measurement objects or measurement identities for measurement and evaluation.

12. A processor for wireless communication, comprising:
at least one controller coupled with at least one memory and configured to cause the processor to:
receive a first message comprising a measurement configuration, wherein the measurement configuration comprises a plurality of measurement identities;
determine, based on measurements associated with at least a first measurement identity in the plurality of measurement identities, that a measurement reporting criterion for at least one cell is satisfied, wherein a measurement or a measurement evaluation associated with a second measurement identity is ongoing;
determine whether a radio quality of a respective cell satisfies a preliminary radio threshold;
generate a measurement report based on the measurements associated with at least the first measurement identity;
add, to the measurement report, an indication that another measurement is in progress and the radio quality of the respective cell satisfies the preliminary radio threshold; and
transmit a second message comprising the measurement report.

13. A base station for wireless communication, comprising:
at least one memory; and
at least one processor coupled with the at least one memory and configured to cause the base station to:
transmit, to a user equipment (UE), a first message comprising a measurement configuration, wherein the measurement configuration comprises a plurality of measurement identities;
receive, from the UE, a first measurement report based on measurements associated with at least a first measurement identity in the plurality of measurement identities, wherein the first measurement report further comprises an indication that another measurement is in progress and a radio quality of an associated cell satisfies a preliminary radio threshold;
start a timer upon reception of the first measurement report;
determine whether one or more second measurement reports are received from the UE prior to expiry of the timer, wherein the one or more second measurement reports are based on measurements associated with at least a second measurement identity in the plurality of measurement identities;
perform a handover decision for the UE based at least in part on the first measurement report, wherein the handover decision is further based on the one or more second measurement reports in response to the one or more second measurement reports being received from the UE prior to expiry of the timer; and
transmit an indication of the handover decision to the UE.

14. The base station of claim 13, wherein the at least one processor is further configured to cause the base station to perform the handover decision prior to expiry of the timer in response to receiving a second measurement report that lacks the indication that another measurement is in progress.

15. The base station of claim 13, wherein the at least one processor is further configured to cause the base station to reset the timer in response to receiving a second measurement report that comprises the indication that another measurement is in progress.

16. The base station of claim 13, wherein the at least one processor is further configured to cause the base station to provision the UE with a radio threshold for preliminary evaluation of a radio quality of a respective cell corresponding to the second measurement identity, and wherein the indication that another measurement is in progress further indicates that the radio quality of the respective cell satisfies the radio threshold.

17. The base station of claim 13, wherein the measurement configuration further comprises a plurality of measurement objects, and wherein each of the plurality of measurement identities corresponds to one of the plurality of measurement objects.

18. The base station of claim 13, wherein the first message comprises a Radio Resource Control (RRC) reconfiguration message or an RRC resume message, and wherein the measurement report comprises an RRC measurement report message.

19. The base station of claim 13, wherein the first measurement report further comprises one or more of:
a set of unmeasured measurement objects;
a set of unmeasured measurement identities;
a set of measurement objects for which measurement and evaluation is ongoing;
a set of measurement identities for which measurement and evaluation is ongoing;
a set of unmeasured measurement objects for which measurement and evaluation is undesired;
a set of unmeasured measurement identities for which measurement and evaluation is undesired;
a set of unmeasured measurement objects for which measurement and evaluation is desired based on a service priority or a network slice priority;
a set of unmeasured measurement identities for which measurement and evaluation is desired based on a service priority or a network slice priority;
an order in which a set of unmeasured measurement objects is to be measured and evaluated;
an order in which a set of unmeasured measurement identities objects is to be measured and evaluated;
a remaining time to complete an ongoing measurement and evaluation associated with the second measurement identity;
or a combination thereof.

20. A method performed by a base station, the method comprising:
transmitting, to a user equipment (UE), a first message comprising a measurement configuration, wherein the measurement configuration comprises a plurality of measurement identities;
receiving, from the UE, a first measurement report based on measurements associated with at least a first measurement identity in the plurality of measurement identities, wherein the first measurement report further comprises an indication that another measurement is in progress and a radio quality of an associated cell satisfies a preliminary radio threshold;
starting a timer upon reception of the first measurement report;
determining whether one or more second measurement reports are received from the UE prior to expiry of the timer, wherein the one or more second measurement reports are based on measurements associated with at least a second measurement identity in the plurality of measurement identities;
performing a handover decision for the UE based at least in part on the first measurement report, wherein the handover decision is further based on the one or more second measurement reports in response to the one or more second measurement reports being received from the UE prior to expiry of the timer; and
transmitting an indication of the handover decision to the UE.
